(19) United States
(12) Patent Application Publication
(10) Pub. No.: US 2018/0175550 A1
(43) Pub. Date: Jun. 21, 2018

(54) UNIVERSAL ADAPTER FOR A PLUG CONNECTOR HEAD AND PLUG CONNECTOR PART HAVING A PLUG CONNECTOR HEAD OF THIS KIND

(71) Applicant: Wieland Electric GmbH, Bamberg (DE)

(72) Inventors: Hans Baumgärtner, Strullendorf (DE); Sebastian Kirchner, Bamberg (DE)

(21) Appl. No.: 15/836,243

(22) Filed: Dec. 8, 2017

(30) Foreign Application Priority Data
Dec. 15, 2016 (DE) 10 2016 124 496.1

(51) Int. Cl. H01R 13/629; H01R 13/516; H01R 24/62

(52) U.S. Cl. CPC H01R 13/62927; H01R 24/62; H01R 13/516

(57) ABSTRACT

An adapter for receiving a plug connector head, comprising a main body that comprises, on an end face, a through-opening for guiding through the plug connector head at least in part. The adapter is intended to be able to receive the plug connector head irrespective of the geometric design of said plug connector head and therefore irrespective of the manufacturer. For this purpose, a slide element is movably mounted on the main body such that the slide element and the main body form a variably sized receiving space for the plug connector head.

### PRIORITY APPLICATION

This patent application claims priority to German patent application number 10 2016 124 496.1, filed on Dec. 15, 2016, entitled “UNIVERSAL ADAPTER FOR A PLUG CONNECTOR HEAD AND PLUG CONNECTOR PART HAVING A PLUG CONNECTOR HEAD OF THIS KIND,” the disclosure of which is hereby incorporated herein by reference in its entirety.

### TECHNICAL FIELD

The invention relates to an adapter for receiving a plug connector head, comprising a main body that comprises, on an end face, a through-opening for guiding through the plug connector head at least in part. The invention also relates to a plug connector part comprising a plug connector head that is received in an adapter of this kind.

### BACKGROUND

Network connectors that are used to connect computers, for example, to networks, e.g. RJ45 connectors, are known from office technology. Connectors of this kind are time-tested, inexpensive components. Furthermore, industrial plug connectors are known that make possible a reliable electrical connection even in environments in which exacting demands are placed on mechanical resistance, resistance to environmental influences, dust and liquid tightness, and workability using common industrial tools.

Moreover, conventional network technologies from the sphere of office communications are making their way into the industrial environment. This is being promoted by the availability of inexpensive and time-tested hardware and software components. As a result of networks and bus systems coming together in the control and power domain, there is a requirement in the industrial domain for network signals to be transmitted. However, the system lines designed for the office environment are not readily suitable for the industrial domain, since they do not at all meet the demands placed on a plug connection with regard to mechanical resistance and sealing.

In order to provide high mechanical resistance and to seal the plug connector heads, they are typically placed in adapter elements and the adapters are encased in a housing that meets the mechanical requirements. However, when network connectors of this kind are used, the problem arises that, while the mating face, e.g. of an RJ45 connector, is standardised, the line receptacle is not. This means that the designs and therefore the measurements and dimensions of the line receptacle including pull reliefs may differ widely.

Adapters for plug connector heads are known from CN 204732630 U and US 2003/0148652 A1, for example.

### SUMMARY

The object of the invention is therefore that of providing an adapter and a plug connector part that can receive the plug connector head irrespective of the geometric design of said plug connector head and therefore irrespective of the manufacturer.

The object is achieved according to the invention by a slide element being movably mounted on the main body such that the slide element and the main body form a variably sized receiving space for the plug connector head.

Advantageous embodiments of the invention can be found in the dependent claims.

The invention is based on the consideration that a universal adapter should be designed such that it is able to accommodate the different geometric designs of the plug connector head, but, in order to preserve the pull relief and ensure proper contacts, should also be designed to be compact enough that the plug connector head is arranged in the adapter securely and without any free space for movement. This is achieved by the adapter being made up of at least two elements. Firstly, the main body, in which the plug connector head is inserted and which comprises a through-opening on an end face so that the contact region of the plug connector head can protrude out of the adapter. Secondly, the adapter is also intended to comprise a slide element that can be pushed onto the main body and forms a variable receiving space, together with said main body, for the plug connector head. As a result of the adapter being separated into two elements, which are designed to be axially movable relative to one another, it is possible to variably adjust the receiving space depending on the geometric shape of the plug connector head and in particular of the base region and the pull relief element of the plug connector head.

So that, during operation of the plug connector head and thus in the final assembled position of the adapter, the receiving space maintains the desired size, fixing elements that fix the slide element in place on the main body, for example, are advantageously provided. In a preferred embodiment, said fixing elements are designed as snap-in locking means, in particular as toothed non-return locking means, between the slide element and the main body. This is advantageous in that, already during the assembly, the slide element can only be moved in one preferred direction, typically towards the main body, in order to reduce the size of the receiving space, and this makes the assembly considerably easier.

The slide element preferably comprises a main plate having a number of projections that extend from the main plate in a substantially rectangular manner. The toothed non-return locking means for fixing the slide element in place can be arranged on said projections. This structure of the slide element makes it possible for the main plate to be able to be moved substantially in parallel with a base plate, which defines the end face of the main body, such that the receiving space is delimited by two surfaces that are oriented in parallel with one another, namely the main plate of the slide element and the base plate of the main element.

In the case of such a design of the main plate, in an advantageous embodiment the plug connector head, in particular the base region and the pull relief element of the plug connector head, is clamped between the main plate of the slide element and the base plate of the main element. As a result, the plug connector head is fixed in a defined position.

For simple assembly and so that the slide element does not have to be guided along the entire line as far as the plug connector head, in an advantageous embodiment the main plate of the slide element comprises a cut-out for receiving the line and guiding it through.

The main plate contains a cut-out that makes it possible to install lines having various diameters. For this purpose, in a preferred embodiment the cut-out is U-shaped. During assembly, the slide element is therefore placed onto the line, the cut-out surrounding the line as far as possible, and can thus be moved along the line towards the main body.

For a particularly simple and material-saving design of the main body, said main body preferably comprises a base plate, which defines the end face, and a number of projections and/or wall elements that extend substantially perpendicularly from the end face. In this case, the fixing elements, for example in the form of a toothed non-return locking means, are arranged on said projections and/or wall elements.

So that the adapter can be rigidly surrounded by an outer housing, the main body advantageously comprises a coupling element that can be arranged on a wall element, for example. The coupling element may be designed to receive an assembly pin of the outer housing; however, it is also possible for a connection screw to connect the outer housing to the coupling elements and thus also to the adapter.

For a particularly effective hold of the plug connector head, for example an RJ45 connector, in the adapter, in an advantageous embodiment the cross section of the through-opening is adapted to the cross section of the contact region of the plug connector head. This makes it possible for the contact region to protrude completely out of the adapter and thus to be able to be inserted into a corresponding mating piece. In an advantageous embodiment, the associated snap-in function of the plug connector head, for example that of an RJ45 connector, is only pushed through the through-opening in part, thereby overriding the snap-in function.

However, the scenario is also avoided in which the base region of the plug connector head, which typically has a different, larger cross section, also emerges from the adapter and the plug connector head could therefore be pushed out of the adapter by the slide element. Optimally adjusting the through-opening also prevents the plug connector head from moving transversely or rotating in the adapter, and this additionally fixes the plug connector head in place.

In a preferred embodiment, the measurements of the adapter, in particular the dimensioning of the main body and the slide, and also the geometric design of the through-opening are adapted to an RJ45 connector. Since, even in the case of RJ45 connectors, the base region and the pull relief element of a plug connector head may be freely designed by the manufacturer, the dimensioning of the adapter is optimised with regard to the typical sizes of these regions so that as large a product range as possible may be covered.

Concerning the plug connector housings, in order to be able to provide housings that are as universal as possible and are designed for a plurality of different plug connector heads, in an advantageous embodiment a plug connector part is also provided that is designed to receive an adapter of this kind. In a preferred embodiment, the housing of the plug connector part is made of metal or plastics material. The housing may be designed such that it completely surrounds the adapter in order to protect the plug connector head or the region of the plug connector head arranged in the receiving space of the adapter from external influences and against the ingress of foreign substances. Of course, other plug connector heads used for data transmission can also be used by the adapter solution.

The advantages achieved by the invention are in particular that, by the adapter being separated into a main body and a slide element, the receiving space can be designed to be variable. It is therefore possible in particular to fit plug connector heads of different lengths and sizes with a single adapter that is adapted to the length of the plug connector head by means of the fixing elements. By using a snap-in locking means, in particular a toothed non-return locking means, the slide element is prevented from moving in the opposite direction of the main body such that the plug connector head is clamped in the adapter in a secure and reliable manner.

### BRIEF DESCRIPTION OF THE DRAWINGS

The invention is described below with reference to a preferred embodiment, which is shown in the accompanying drawings, in which:

FIG. 1 shows a plug connector head together with a main body of an adapter;

FIG. 2 shows a plug connector head in a main body of an adapter;

FIG. 3 shows a plug connector head together with an adapter during assembly;

FIG. 4 shows a slide element;

FIG. 5 shows a plug connector head together with an adapter in the final assembled position; and

FIG. 6 shows a plug connector part.

### DETAILED DESCRIPTION

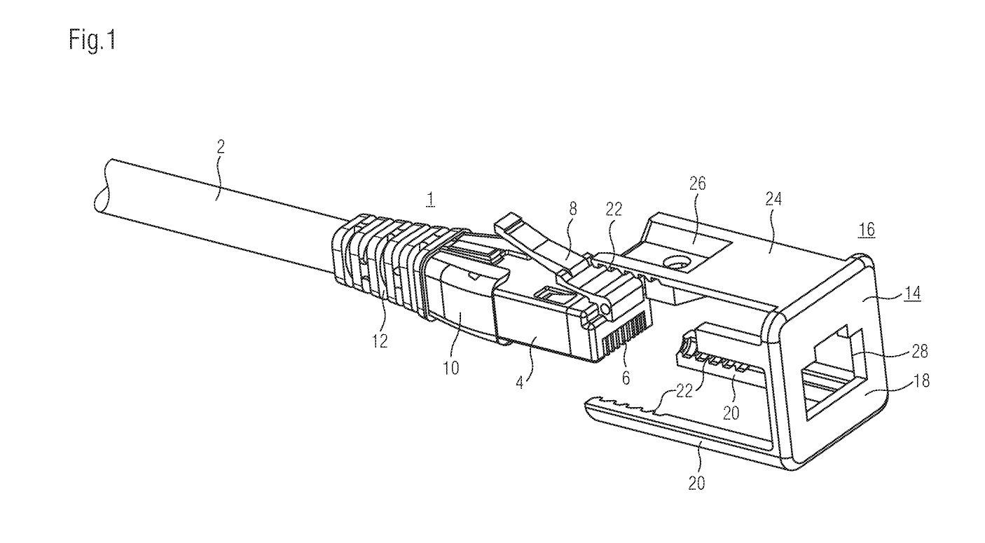

FIG. 1 shows a plug connector head 1 for data lines, in particular provided in the industrial domain. The plug connector head 1 is arranged at an end of a line 2 comprising a number of data lines. The data lines are guided through the plug connector head 1 and end in a contacting region 4. In the contacting region 4, the data lines, which are formed as conductors or wires, are each associated with a contact element 6. In order to transmit data and to form a plug connection, the contacting region 4 is designed such that it can be inserted into a plug connector socket (not shown) accordingly adapted to said contacting region. The data lines are guided further via corresponding contact regions of the plug connector socket such that it is possible to transfer and transmit the data. For a secure connection of the contacting region 4 to the plug connector socket, the contacting region 4 comprises a snap-in lock 8, which prevents the contacting region 4 from becoming unintentionally released from the plug connector socket, but which also makes it possible at the same time for the plug connector head 1 to be both plugged into the plug connector socket and disconnected again.

In the plug connector head 1, starting from the contacting region 4 a base region 10 extends towards the line 2, which base region is adjoined by the pull relief element 12. This pull relief element 12 is fixedly connected to the line 2 and diverts mechanical tensile loads acting on the line 2 or the plug connector head 1 such that said loads are not transferred to the data lines in the form of conductors or wires. This makes it possible to prevent tensile forces on the individual data lines or also in the region of the connection to the contact elements.

FIG. 1 also shows a main body 14 of an adapter 16 for plug connector heads 1. The main body 14 comprises a base plate 18 that defines the end face of the main body 14. Two snap-in projections 20 extend from said square base plate 18 at two corners at a substantially perpendicular angle. Said snap-in projections 20 are substantially linear and each comprise, on the ends thereof that are remote from the base plate 18, a part of a fixing element 22, which part is designed as a toothed non-return locking means. Furthermore, a wall element 24 extends on a longitudinal side of the base plate 18, which wall element also extends from the base plate 18 at a substantially perpendicular angle and in the same direction as and in parallel with the snap-in projections 20. The wall element 24 also comprises, in the end region, i.e. the region that is remote from the base plate 18, a part of the fixing element 22, which part comprises two toothed non-return locking means. Furthermore, a coupling element 26 for being connected to an outer housing (not shown) is arranged in the wall element 24. For this purpose, the coupling element 26 is designed to receive an assembly pin or a connection screw and to thereby connect the outer housing to the main body 14 of the adapter 16.

The base plate 18 of the main body 14 comprises a through-opening 28 which, in the geometric designs thereof, is adapted to the cross section of the contacting region 4 of the plug connector head 1.

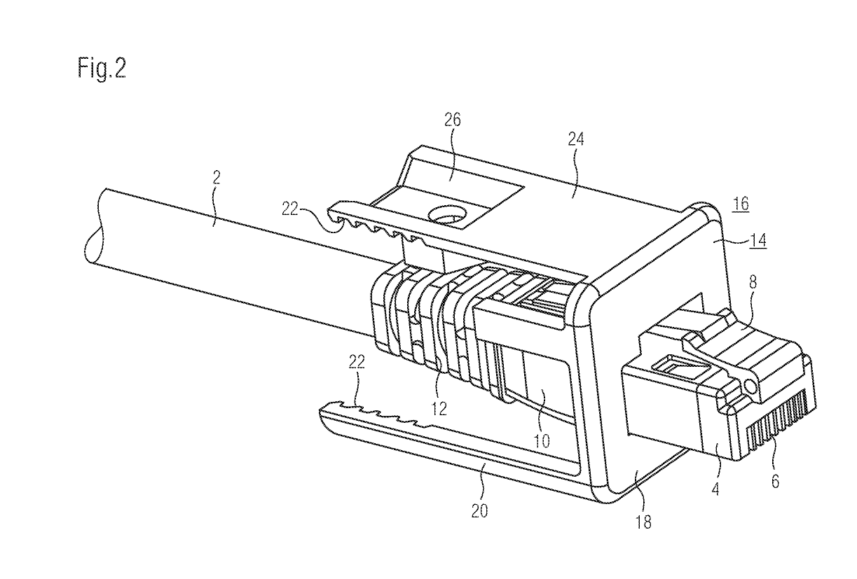

As shown in FIG. 2, during assembly the plug connector head 1 is guided into the main body 14 of the adapter 16 such that the snap-in projections 20 and the wall element 24 point towards the line 2. In the process, the contacting region 4 of the plug connector head 1 is guided substantially completely through the through-opening 28 in the base plate 18 such that the base plate 18 visually separates the contacting region 4 from the base region 10 and the pull relief element 12 of the plug connector head 1.

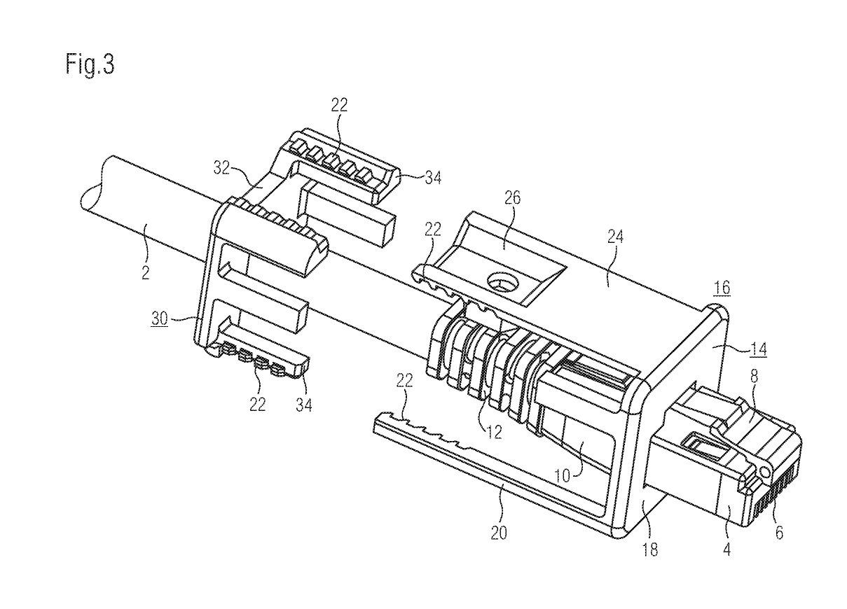

FIG. 3 shows the slide element 30 of the adapter 16 for the first time. The slide element 30 comprises a substantially square main plate 32 from which a snap-in projection 34 extends at a substantially perpendicular angle in each of the four corner regions. Said snap-in projections 34 also each comprise, in an end region that is remote from the main plate 32, a part of the fixing element 22, which part is designed as a toothed non-return locking means in this case too. The main plane of the main plate 32 and the orientation and arrangement of the toothed non-return locking means of the slide element 30 are matched to the main plane of the base plate 18 and the orientation and arrangement of the toothed non-return locking means of the main body 14 such that the respective fixing elements 22 are brought together in the final assembled position and the toothed non-return locking means mesh with one another.

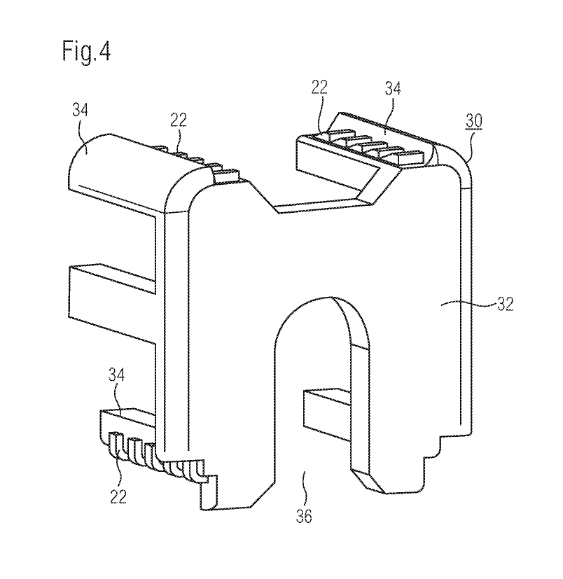

In FIG. 4, the slide element 30 is shown again from a different perspective. As can be seen from this view, the main plate 32 of the slide element 30 also comprises a cut-out 36 which is open at one side of the main plate 32 and is adapted to the cross section of the line 2.

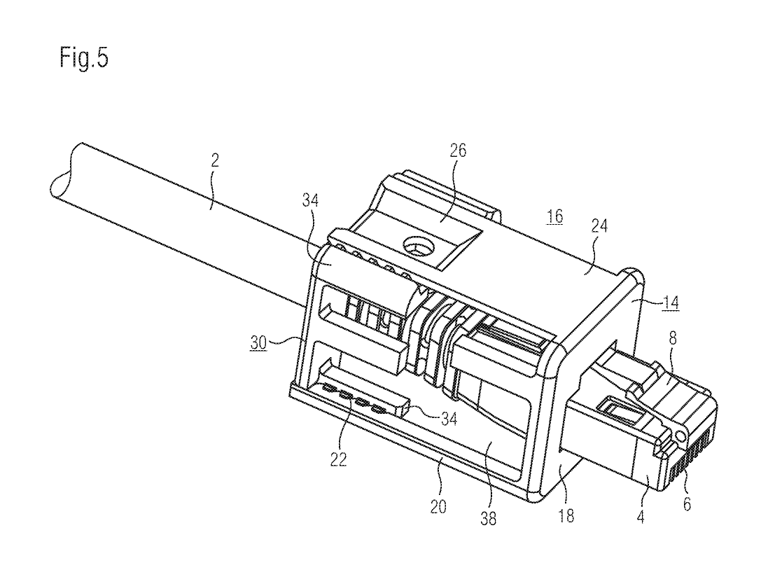

For the assembly, the slide element 30 is pushed onto the line 2 perpendicularly such that the line 2 is positioned in the cut-out 36 in the main plate 32. Here, the snap-in projections 34 point towards the plug connector head 1 and therefore also towards the main body 14 of the adapter 16. Subsequently, the slide element 30 is moved towards the plug connector head 1 such that the toothed non-return locking means of the slide element 30 and the toothed non-return locking means of the main body 14 mesh with one another and form a snap-in locking means. On account of the use of a toothed non-return locking means, the slide element 30 can then only be moved towards the main body 14. The slide element 30 is subsequently moved further towards the main body 14 until the base region 10 and the pull relief element 12 of the plug connector head 1 are clamped between the base plate 18 of the main body 14 and the main plate 32 of the slide element 30. This final assembled position of the adapter 16 is shown in FIG. 5.

It is then only possible to release the slide element 30 if the adapter 16 is not installed in a housing, by either the snap-in projections 20 or the wall element 24 of the main body 14 being moved outwards or downwards.

In this final assembled position, the adapter 16 therefore forms a receiving space 38 for the plug connector head 1, which space, depending on how far the slide element 30 is pushed towards the main body 14, is designed to be variable in the longitudinal direction and can therefore be optimally adjusted to the length of the plug connector head 1 and in particular to the length of the base region 10 and of the pull relief element 12. For further stability of the adapter 16, in the embodiment according to FIG. 5 two snap-in projections 34 of the slide element 30 and two snap-in projections 20 of the main body 14 form the four edges of the adapter 16 in the region of the fixing elements 22 of the slide element 30 and of the main body 14.

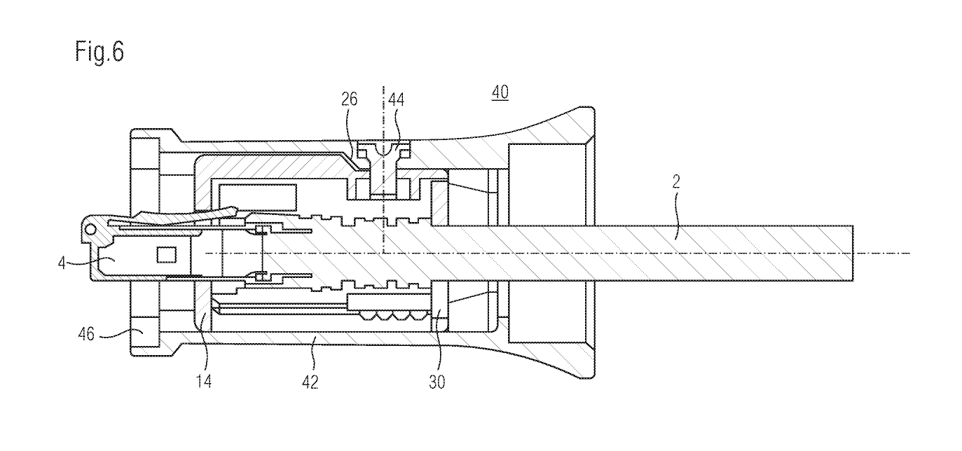

FIG. 6 is a cross section of a plug connector part 40. The plug connector part 40 comprises a plug connector head 1 that is installed in an above-described multiple-part adapter 16. In FIG. 6, said adapter 16 is surrounded by a housing 42 in order to prevent the ingress of foreign substances from outside into the adapter 16 and onto the plug connector head 1. The housing 42 is fixed to the adapter 16 by means of a connection screw 44. For this purpose, the connection screw 44 engages in the coupling element 26 of the adapter 16.

In the embodiment according to FIG. 6, the housing 42 is formed in one part and is pushed over the adapter 16 from the line 2 side and subsequently fixed in place. In a subsequent assembly step, the base plate 18 of the main body 14 can also be covered by a front plate 46 that is fastened to the edge of the housing 42 by appropriate means. However, the housing 42 may also alternatively be formed in multiple parts, in particular in two parts, the individual housing elements then surrounding the adapter 16 and being interconnected.

### LIST OF REFERENCE SIGNS

1 plug connector head
2 line
4 contacting region
6 contact element
8 snap-in lock
10 base region
12 pull relief element
14 main body
16 adapter
18 base plate
20 snap-in projection
22 fixing element
24 wall element
26 coupling element
28 through-opening
30 slide element
32 main plate
34 snap-in projection
36 cut-out
38 receiving space
40 plug connector part
42 housing
44 connection screw
46 front plate

What is claimed is:

1. Adapter for receiving a plug connector head, comprising a main body that comprises, on an end face, a through-opening for guiding through the plug connector head at least in part, characterized in that a slide element is movably mounted on the main body such that the slide element and the main body form a variably sized receiving space for the plug connector head.

2. Adapter according to claim 1, characterized by at least one fixing element which fixes the slide element in place in its final assembled position.

3. Adapter according to claim 2, characterized in that the fixing element is designed as a snap-in locking means.

4. Adapter according to claim 1, characterized in that the slide element comprises a main plate having a number of projections that extend in a substantially rectangular manner.

5. Adapter according to claim 4, characterized in that the receiving space is delimited by the end face of the main body and the main plate of the slide element, the plug connector head being clamped between the end face and main plate in the final assembled position.

6. Adapter according to claim 4, characterized in that the main plate of the slide element comprises a cut-out.

7. Adapter according to claim 1, characterized in that the main body comprises a number of projections and/or wall elements that extend from the end face in a substantially rectangular manner.

8. Adapter according to claim 1, characterized in that the main body comprises a coupling element for receiving an assembly pin.

9. Adapter according to claim 1, characterized in that the cross section of the through-opening is adapted to the cross section of a contact region of the plug connector head.

10. Adapter according to claim 1, characterized in that said adapter is designed to receive a RJ45 plug connector head.

11. A plug connector part comprising a plug connector head that is received in an adapter according to claim 1.
